(19) United States
(12) Patent Application Publication
(10) Pub. No.: US 2025/0030375 A1
(43) Pub. Date: Jan. 23, 2025

(54) DATA-ANALYSIS-BASED CONTROL OPTIMIZATION OF FLOATING SOLAR ARRAY SYSTEM ENERGY HARVESTING

(71) Applicant: INTERNATIONAL BUSINESS MACHINES CORPORATION, Armonk, NY (US)

(72) Inventors: Sarbajit K. RAKSHIT, Kolkata (IN); Jagabondhu HAZRA, Bangalore (IN); Manikandan PADMANABAN, Chennai (IN)

(21) Appl. No.: 18/356,378

(22) Filed: Jul. 21, 2023

(51) Int. Cl. H02S 10/10; H02N 2/18; H02S 50/00

(52) U.S. Cl. CPC H02S 10/10; H02N 2/186; H02S 50/00

(57) ABSTRACT

Data-analysis-based processes for optimizing energy harvesting from a floating solar array system are provided. The processes include obtaining a data-analysis-based control to control energy harvesting from a floating solar array system on water. The floating solar array system includes a floating solar array to harvest solar energy and a kinetic energy harvester to harvest kinetic energy. The data-analysis-based control is configured to determine an environmental condition to effect the floating solar array system, and to dynamically adjust a configuration of the floating solar array system to optimize net energy harvesting of the floating solar array system from the floating solar array and the kinetic energy harvester based on the determined environmental condition to effect the floating solar array system.

### BACKGROUND

This disclosure relates generally to facilitating energy harvesting, and in particular, to enhancing energy harvesting from a floating solar array system on water.

The energy sector accounts for a significant portion of total greenhouse gas emissions globally. Many countries are aligning their support towards clean energy, including solar energy generation. With increasing focus on renewable, sustainable and clean energy, energy systems are expected to continue undergoing transformations to meet the growing demands for clean energy. For example, floating solar array energy generation is expected to undergo significant growth over the coming years.

A solar array, or solar cell array, can include one or more solar cell panels, or photovoltaic panels, which are an assembly of photovoltaic solar cells that capture sunlight as a source of radiant energy that is converted into electricity in the form of direct current (DC) electricity. Solar cells can be made of a variety of technologies. For instance, solar cells can be made of crystalline silicon wafers, or be based on thin-film silicon technologies. In other implementations, solar cells can be based on amorphous silicon. Other solar cell technologies are also possible in the art. Solar cell arrays are used in a variety of applications.

### SUMMARY

Certain shortcomings of the prior art are overcome, and additional advantages are provided herein through the provision of a computer-implemented method of facilitating energy harvesting. The computer-implemented method includes obtaining a data-analysis-based control to control energy harvesting from a floating solar array system on water, where the floating solar array system includes a floating solar array to harvest solar energy, and a kinetic energy harvester to harvest kinetic energy. The control is configured to determine an environmental condition to effect the floating solar array system, and to dynamically adjust a configuration of the floating solar array system to optimize net energy harvesting of the floating solar array system from the floating solar array and the kinetic energy harvester based on the determined environmental condition to effect the floating solar array system.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with a floating solar array system control module, in accordance with one or more aspects of the present disclosure;

FIG. 3 depicts one embodiment of a floating solar array system control workflow, in accordance with one or more aspects of the present disclosure;

FIG. 4A depicts one embodiment of a floating solar array system environment to include and/or use one or more aspects of the present disclosure;

FIG. 4B depicts one embodiment of a floating solar array system to be controlled, in accordance with one or more aspects of the present disclosure;

FIG. 4C schematically illustrates one embodiment of an electromagnetic energy harvester for a kinetic energy harvester of a floating solar array system, such as the floating solar array system embodiments of FIGS. 4A-4B, in accordance with one or more aspects of the present disclosure;

FIG. 5 is a further example of a computing environment to include and/or use one or more aspects of the present disclosure;

FIG. 6A depicts one example of a data-analysis-based energy harvesting control workflow, in accordance with one or more aspects of the present disclosure;

FIG. 6B depicts one embodiment of a machine learning model training workflow to train a machine learning model to predict wave frequency at a location of the floating solar array system, in accordance with one or more aspects of the present disclosure;

FIG. 6C depicts an example data-analysis-based control workflow to determine natural wave frequency of water about a floating solar array system, in accordance with one or more aspects of the present disclosure;

FIG. 7A depicts one example of a data-analysis-based control algorithm for modulating piezoelectric resonant frequency of a piezoelectric spring energy harvester to facilitate optimizing energy generation from a kinetic energy harvester of a floating solar array system, in accordance with one or more aspects of the present disclosure;

FIG. 7B graphically illustrates a resonant frequency plot of a piezoelectric spring energy harvester to be modulated to facilitate energy harvesting, in accordance with one or more aspects of the present disclosure;

FIG. 8 depicts another workflow embodiment to determine one or more environmental conditions to effect a floating solar array system, and to dynamically adjust configuration of the floating solar array system to optimize energy harvesting, in accordance with one or more aspects of the present disclosure; and

FIG. 9 depicts one example of a data-analysis-based control algorithm for optimizing net energy harvesting of a floating solar array system from a floating solar array and kinetic energy harvester of the system by dynamically controlling solar array panel angles, in accordance with one or more aspects of the present disclosure.

### DETAILED DESCRIPTION

The accompanying figures, which are incorporated in and form a part of this specification, further illustrate the present disclosure and, together with this detailed description of the disclosure, serve to explain aspects of the present disclosure. Note in this regard that descriptions of well-known systems, devices, processing techniques, etc., are omitted so as to not unnecessarily obscure the disclosure in detail. It should be understood, however, that the detailed description and this specific example(s), while indicating aspects of the disclosure, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

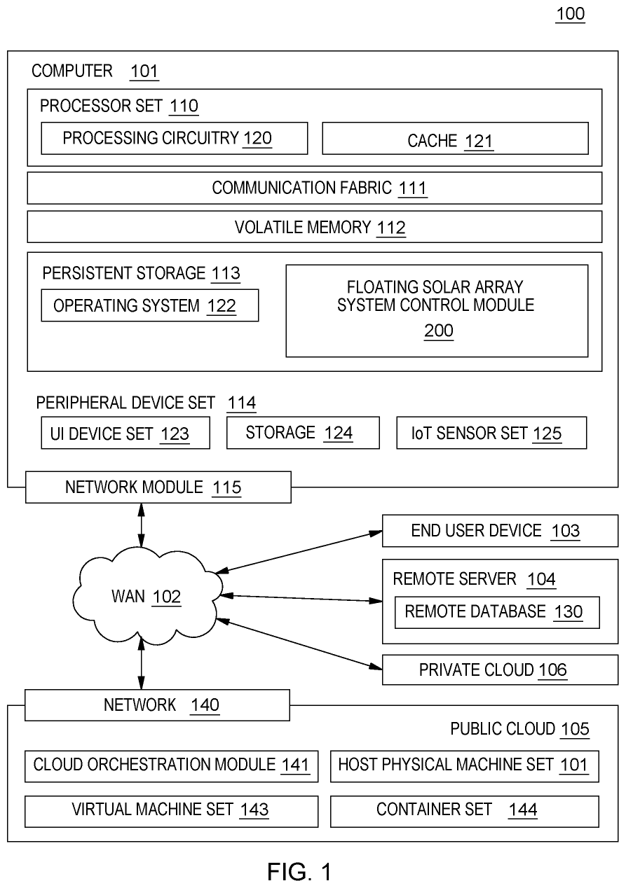

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and floating solar array system control module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform floating solar array system control processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as floating solar array control system module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

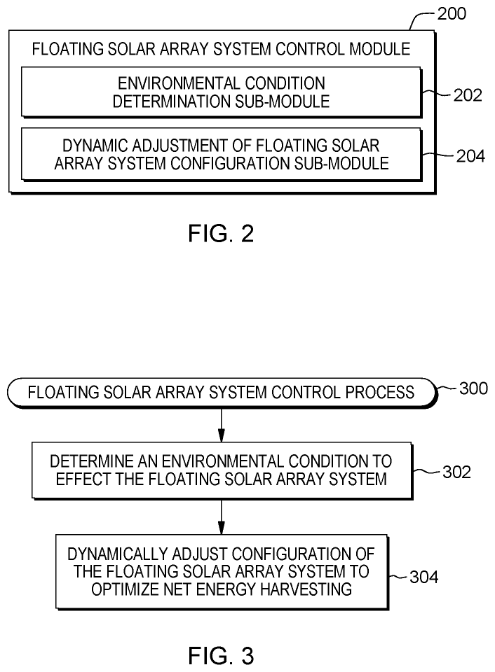

By way of example, one or more embodiments of a floating solar array system control module and process are described initially with reference to FIGS. 2-3. FIG. 2 depicts one embodiment of floating solar array system control module 200 that includes code or instructions to perform floating solar array system control processing, in accordance with one or more aspects of the present disclosure, and FIG. 3 depicts one embodiment of a floating solar array system control process, in accordance with one or more aspects of the present disclosure.

Referring to FIGS. 1-2, floating solar array control system module 200 includes, in one example, various sub-modules used to perform processing, in accordance with one or more aspects of the present disclosure. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

As noted, FIG. 2 depicts one embodiment of a floating solar array system control module 200 which, in one or more embodiments, includes, or provides, a control, or data-analysis-based control, to control energy harvesting from a floating solar cell array system on water. The floating solar array system includes a floating solar array to harvest solar energy and a kinetic energy harvester to harvest kinetic energy. Note in this regard that, “kinetic energy harvester” is used herein to refer to an energy harvester capable of harvesting, at least in part, kinetic and/or potential energy effecting the floating solar array system, including (for instance) wave energy and/or wind energy. In the embodiment of FIG. 2, example sub-modules of floating solar array system control module 200 include an environmental condition determination sub-module 202 to determine an environmental condition to effect the solar array system, and a dynamic adjustment of floating solar array system configuration sub-module to dynamically adjust a configuration of the floating solar array system to optimize net energy harvesting of the floating solar array system from the floating solar array and the kinetic energy harvester, based on the determined environmental condition to effect the solar array system. Advantageously, obtaining a data-analysis-based control such as disclosed herein facilitates, in one or more embodiments, net energy harvesting from a floating solar array system on water which includes multiple types of energy harvesting, including solar energy harvesting and kinetic energy harvesting from the waves and/or wind. The data-analysis-based control is configured, in one embodiment, to dynamically adjust the configuration of the floating solar array system to optimize net energy harvesting, such as for instance, for a forecast time interval. Note that although various sub-modules are described, floating solar array control module processing such as disclosed herein can use, or include, additional, fewer, and/or different sub-modules. A particular sub-module can include additional code, including code of other sub-modules, or less code. Further, additional and/or other modules can be used. Many variations are possible.

In one or more embodiments, the sub-modules are used, in accordance with one or more aspects of the present disclosure, to perform floating solar array system control processing. FIG. 3 depicts one example of a floating solar array system control process, such as disclosed herein. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as floating solar array system control module 200. In other examples, the code can be included in one or more other modules and/or in one or more sub-modules of the one or more other modules. Various options are available.

As one example, floating solar array system control process 300 executing on a computer (e.g., computer 101 of FIG. 1), a processor (e.g., a processor of processor set 110 of FIG. 1), and/or processing circuitry (e.g., processing circuitry of processor set 110), determines an environmental condition to effect the floating solar array system 302. Depending on the implementation, the environmental condition can be one of a variety of environmental conditions. For instance, in one or more implementations, the floating solar array system includes one or more floating solar arrays to harvest solar energy and one or more kinetic energy harvesters to harvest kinetic and/or potential energy. Solar energy is harvested based, for instance, on available solar irradiance, and kinetic energy is harvested from, for instance, from available wave and/or wind energy, such as available wave and/or wind energy impacting the floating solar array(s), and/or impacting the floating platform supporting the floating solar array(s).

In one or more embodiments, the floating solar array system control process 300 further includes dynamically adjusting configuration of the floating solar array system to optimize net energy harvesting 304. For instance, in one or more embodiments, the kinetic energy harvester includes a piezoelectric spring-type energy harvester, and the dynamically adjusting configuration of the floating solar array system includes modulating, by the control, piezoelectric resonant frequency of the piezoelectric spring energy harvester to match a determined natural wave frequency of the water to optimize energy generation from the piezoelectric spring energy harvester. The determined natural wave frequency can be a currently determined natural wave frequency of the water about the floating solar array system, or a predicted natural wave frequency of the water about the floating solar array system for a forecast time interval. In another example, the dynamically adjusting configuration of the floating solar array system to optimize net energy harvesting of the floating solar array system includes dynamically adjusting slope of one or more solar panels of the floating solar array to facilitate optimizing, for instance, either solar array harvesting and/or kinetic energy harvesting (e.g., from wind) for a forecast time period. For instance, in one embodiment, the floating solar array system includes movable solar array support structures with an electro-mechanical control mechanism to facilitate dynamic control of, for instance, solar panel slopes (or angles) of the floating solar array to assist with capture of wind energy impacting the floating solar array system. In addition, in one or more embodiments, the floating solar array system includes a positioning or propulsion system controllable by the data-analysis-based control of the floating solar array system to, for instance, facilitate reorienting the floating solar array system to enhance capture of wind energy by the kinetic energy harvester of the floating solar array system relative to a predicted direction of wind to impact the floating solar array system.

Generally stated, disclosed herein are computer-implemented methods, computer systems, and computer program products for facilitating energy harvesting, and in particular, for facilitating energy harvesting from a floating solar array system on water, where the floating solar array system includes a control, one or more floating solar arrays to harvest solar energy, and one or more kinetic energy harvesters to harvest kinetic energy, such as wave energy and/or wind energy. The control is a data-analysis-based control configured to determine one or more environmental conditions to effect the floating solar array system, and to dynamically adjust a configuration of the floating solar array system to optimize net energy harvesting of the floating solar array system from the floating solar array and the kinetic energy harvester based on the determined environmental condition(s) to effect the floating solar array system.

In one or more embodiments, the floating solar array of the floating solar array system is coupled to a fixed anchor structure by a line, such as an elastic line, having the kinetic energy harvester coupled thereto. In one embodiment, the kinetic energy harvester is connected to, and/or forms a portion of, the line connecting the floating solar array to the anchor structure.

In one or more embodiments, the kinetic energy harvester includes a piezoelectric energy harvester, such as a piezoelectric spring-type energy harvester, which converts extension and compression energy on the line into electrical energy. In this configuration, the data-analysis-based control is configured (in one embodiment) to determine a natural wave frequency of the water, and to modulate a piezoelectric resonant frequency of the piezoelectric spring energy harvester to match the determined natural wave frequency of the water, and thereby optimize energy generation from the piezoelectric spring energy harvester.

In one or more embodiments, the data-analysis-based control is configured to determine the natural wave frequency of the water using a machine learning model trained to provide a modeled natural wave frequency of the water using, for instance, latitude and longitude data for a location of the floating solar array system, time of day data, wind speed data for the floating solar array system location, and/or day of year data, etc. In one or more embodiments, the data-analysis-based control is further configured to determine the natural wave frequency of the water by obtaining an estimated natural wave frequency of the water using satellite image data of the water, and determining the natural wave frequency of the water using both the modeled natural wave frequency of the water and the estimated natural wave frequency of the water. In one embodiment, the data-analysis-based control is further configured to determine the natural wave frequency of the water using a weighting of the modeled natural wave frequency of the water combined with a weighting of the estimated natural wave frequency of the water.

In one or more alternate or further implementations, the floating solar array is coupled to an anchor structure by a line having the kinetic energy harvester coupled thereto, and the data-analysis-based control is further configured to determine potential solar irradiance of the floating solar array for a forecast time period, and determine potential kinetic energy on the kinetic energy harvester for the forecast time period. Further, the data-analysis-based control is configured to dynamically adjust the configuration of the floating solar array system to optimize net energy harvesting of the floating solar array system for the forecast time period using the determined potential solar irradiance and the determined potential kinetic energy. By way of specific example, where the forecast time period includes a forecasted daylight time period, the floating solar array system can be dynamically configured to optimize energy harvesting of the floating solar array, and in another example, where the forecast time period is a nighttime period, the floating solar array system can be dynamically adjusted to optimize net energy harvesting of the kinetic energy harvester (e.g., from wave energy and/or wind energy).

For instance, in one or more embodiments, the floating solar array includes adjustable solar panels, and dynamically adjusting the configuration of the floating solar array system includes dynamically adjusting slope of one or more solar panels of the floating solar array to facilitate optimizing harvesting of kinetic energy for a forecast time period, and thereby optimize net energy harvesting of the floating solar array system for the forecast time period (such as a nighttime period) based on the determined environmental condition to effect the floating solar array system (e.g., a lack of solar irradiance). In one or more embodiments, the environmental condition is selected from the group consisting of: wave action to effect the floating solar array system for the forecast time period; wind to effect the floating solar array system for the forecast time period; and solar irradiance to effect the solar array system for the forecast time period.

In one or more such embodiments, the floating solar array of the floating solar array system is coupled to an anchor structure by a line having the kinetic energy harvester coupled thereto, and the kinetic energy harvester includes a piezoelectric spring energy harvester. In one embodiment, the data-analysis-based control is configured to determine a natural wave frequency of the water, and to modulate a piezoelectric resonant frequency of the piezoelectric spring energy harvester to match the determined natural wave frequency of the water to optimize energy generation from the piezoelectric spring energy harvester. This control action is further in combination, in one embodiment, with the dynamically adjusting configuration of the floating solar array system by adjusting slope of one or more solar panels of the floating solar array to facilitate optimizing harvesting of kinetic energy for the forecast time period, such as, for instance, for a nighttime forecast time period. In this manner, both wave energy and wind energy capture can be optimized for a given forecast time period. For instance, in one or more embodiments, the data-analysis-based control is configured to determine potential solar irradiance of the floating solar array for a forecast time period, and determine potential kinetic energy on the floating energy harvester for the forecast time period. Using this information, the data-analysis-based control dynamically adjusts configuration of the floating solar array system to optimize net energy harvesting of the floating solar array system for the forecast time period.

In one or more implementations disclosed herein, the floating solar array system includes a floating platform having one or more solar arrays positioned thereon, with the floating platform being connected to one or more anchor structures disposed, for instance, on a seabed or lakebed, via a respective line so that one end of the line is fixed, and the other end is connected to the floating platform. In one or more embodiments, the line has one or more kinetic energy harvesters coupled thereto, such as one or more piezoelectric springs integrated as part of the line, so that when a wave moves the floating platform, the piezoelectric spring is compensating, at least in part, by expanding and contracting. As each piezoelectric spring expands and contracts, electric power is generated.

In one or more implementations, the attached kinetic energy harvester(s) can additionally, or alternatively, include one or more electromagnetic modules which are coupled to the line to expand and contract with wave and/or wind action on the floating platform, and thereby cause relative movement between a magnetic cylinder and a surrounding coil of the electromagnetic module, which generates electrical energy.

Further, in one or more implementations, based on wind direction and velocity, the floating solar array system can be positioned and oriented to maximize harvesting of the wind energy. For instance, the slope of one or more solar panels of the floating solar array can be dynamically adjusted by the control to facilitate optimizing kinetic wind energy capture for a forecast time period, and/or a positioning or propulsion system can be activated by the control to reorient the floating solar array system to optimally capture kinetic energy resulting from anticipated wind for a forecast time interval. Depending on the time of day (e.g., whether daytime or nighttime), as well as other environmental conditions, aggregated power is optimized, including, generation of solar power, piezoelectric power, and (in one embodiment) electromagnetic-effect-based power, so that with unit-area utilization, power generation is optimized.

By way of specific example, computer-implemented methods, computer systems and computer program products are disclosed herein which optimize net energy capture of a floating solar array system having both a solar array(s) and a kinetic energy harvester(s). For instance, in one embodiment, net energy harvesting is optimized by obtaining one or more of satellite image data, wind pattern data, solar irradiance data, time of day data, geolocation data, etc., to learn and predict the natural frequency of waves upon which the floating solar array system resides, as well as potential wave energy, and leverages the energy generation potential of both the solar arrays and kinetic energy harvesters. In one embodiment, the kinetic energy harvester(s) can include a piezoelectric spring-type energy harvester and/or an electromagnetic energy harvester to facilitate capturing wind energy and/or wave energy, either separately or in combination with capturing solar energy. Where the energy harvester includes a piezoelectric energy harvester, the control dynamically adjusts a configuration of the floating solar array system by modulating the piezoelectric resonant frequency to, for instance, match the natural frequency of the actual or predicted waves to maximize electricity generation from the piezoelectric springs (in one embodiment), and/or dynamically adjust configuration of the floating solar system by changing a slope of solar panels of the floating solar array to optimize electricity generation from one, or both, solar irradiance and wind impacting the floating solar array system. Advantageously, disclosed herein is a data-analysis-based control of energy harvesting from a floating solar array system which optimizes, in one or more embodiments, operating frequency of a piezoelectric spring-type energy harvester to create resonance with, for instance, a sea wave natural frequency, to maximize energy harvest from the piezoelectric springs, as well as optimize a slope angle of the solar panels to maximize energy harvest from solar irradiance and/or impact of wind on the solar panels by accounting for wind speed and direction, and potential solar irradiance, along with satellite observations for a predicted time interval.

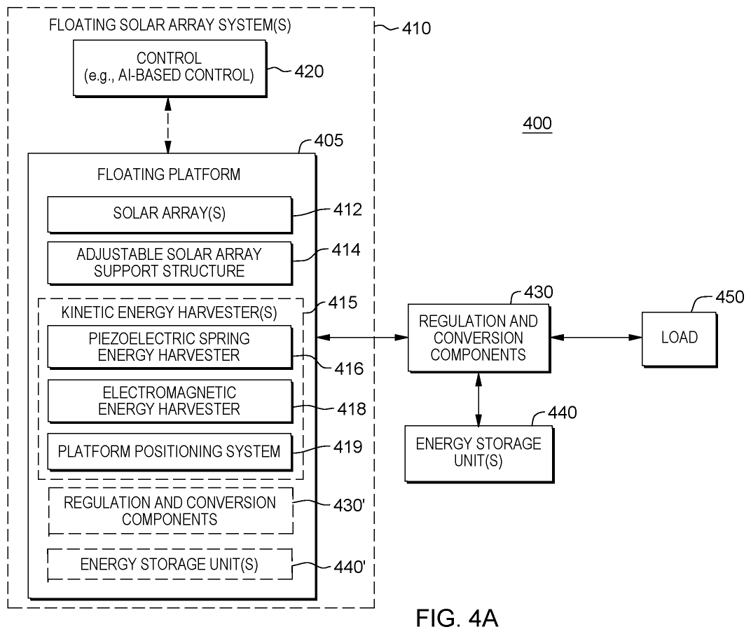

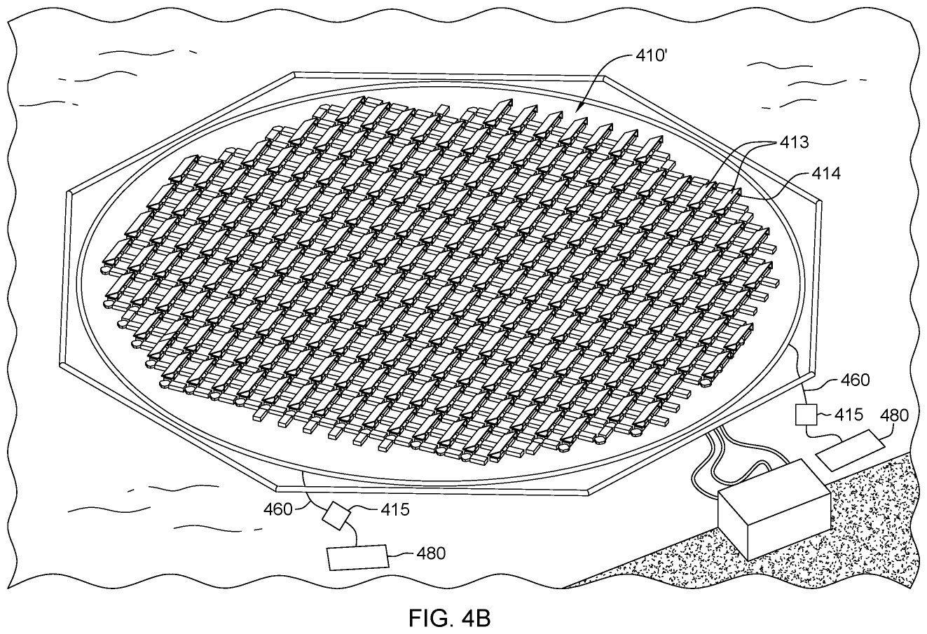

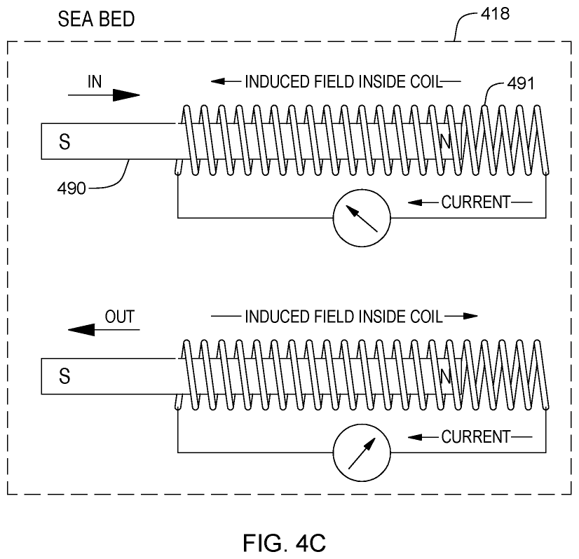

One embodiment of a floating solar array (or floating photovoltaics) system 410 and system environment 400 is depicted in FIG. 4A. As depicted, system environment 400 includes one or more floating solar array systems 410, each of which includes a floating platform 405 and a control 420, such as an artificial-intelligence-based control to facilitate energy harvesting, in accordance with one or more aspects of the present disclosure. In one or more embodiments, floating platform 405 is a support structure configured to float on water and can be, at least in part, a foam-based floating support structure. For instance, by way of example, floating platform 405 can be configured to float on a body water, such the ocean, a lake, a river, a canal, etc. As illustrated in FIG. 4A, floating platform 405 includes one or more solar arrays 412 mounted on, or supported by, respective adjustable solar array support structures 414, such as electromechanically-controlled support structures which allow the slope of individual solar panels of the solar array to be dynamically adjusted to, for instance, facilitate energy harvesting, such as described herein.

In one or more embodiments, in addition to solar array(s) 412, floating platform 405 has associated therewith one or more kinetic energy harvesters 415 including, in one or more embodiments, one or more piezoelectric spring energy harvesters 416, and/or one or more electromagnetic energy harvesters 418, as well as one or more platform positioning systems 419, such as one or more pump-jets or water-jets that produce jets of water for, for instance, changing orientation of the floating platform 405 relative to waves, wind, and/or solar irradiance. In one or more embodiments, platform positioning system 419 can include a plurality of pump-jets arranged around floating platform 405 to allow movement or rotating of the platform in any direction to facilitate, for instance, reorienting of the floating platform, such as discussed herein.

Control 420 is, in one embodiment, a data-analysis-based control, such as an artificial-intelligence-based control (i.e., controller or control system) in communication with floating platform 405 to facilitate data-analysis-based control to control energy harvesting from the floating platform, including from solar array(s) 412 and kinetic energy harvester(s) 415. Note that although control 420 is shown separate from floating platform 405, in one or more implementations, control 420 can be located on, or otherwise integrated with, floating platform 405. As explained, in one or more embodiments, control 420 is configured to determine one or more environmental conditions to effect the floating solar array system, and to dynamically adjust the configuration of the floating solar array system to optimize net energy harvesting of the floating solar array system from the floating solar array (e.g., solar array(s) 412) and the kinetic energy harvester (e.g., kinetic energy harvester(s) 415) based on the determined environmental condition(s) to effect the floating solar array system, such as for a forecast time period.

As noted, in one or more embodiments, kinetic energy harvester(s) 415 includes one or more piezoelectric spring energy harvester(s) 416 which can be, or include, a bi-layered structure that includes a surface electrode and a ferroelectric polymer on a spring. In one embodiment, a line, such as an elastic line, connects floating platform 405 to a fixed anchor structure, and the kinetic energy harvester, such as piezoelectric spring energy harvester(s) 416, is integrated or coupled as part of the line connecting floating platform 405 to the anchor structure, so that the piezoelectric spring energy harvester(s) 416 undergoes extension and contraction with wave energy and/or wind energy force on floating platform 405.

In one or more embodiments, in addition to, or in place of, piezoelectric spring energy harvester(s) 416, one or more electromagnetic energy harvesters 418 can be included in, or coupled to as part of, the line coupling floating platform 405 to the fixed anchor structure. For instance, in one or more embodiments, electromagnetic energy harvester(s) 418 can include one or more coils, such as one or more copper coils surrounding a magnet to generate power as the magnet reciprocates. In this manner, the electromagnetic energy harvester translates with movement or vibration of floating platform 405 due the wave energy and/or wind energy, and thereby generates electrical energy. Further, those skilled in the art will note that piezoelectric spring energy harvester(s) 416, and electromagnetic energy harvester(s) 418, as well as the solar array(s) 412, can operate together to generate a net energy from the floating solar array system. The energy generation components are electrically coupled via respective conductive lines to transfer harvested energy to, for instance, regulation and conversion components 430 which, for instance, regulate and convert generated DC electricity to AC electricity to, for instance, power a load 450, and/or to store generated energy in one or more energy storage units 440, such as one or more battery storage units. In one or more implementations, regulation and conversion componentry 430′ and/or energy storage unit(s) 440′ can also, or alternatively, be associated with, or mounted to, floating platform 405.

In one or more embodiments, cabling, such as underwater cabling, couples floating platform 405, and in particular, solar array(s) 412 and kinetic energy harvester(s) 415, to one or more land-based components, such as to land-based regulation and conversion components 430, energy storage unit(s) 440, and/or load 450. In one or more other implementations, regulation and conversion components 430 and/or energy storage unit(s) 440 can alternatively be positioned at a fixed location in the water, such as underwater on a seabed, lakebed, etc., with cabling connecting to floating platform 405. In one or more embodiments, the cabling is configured with a length which allows for dynamic reorienting of the floating platform, such as discussed herein.

FIG. 4B depicts an example embodiment of a floating solar array system 410′, such as floating solar array system 410 of FIG. 4A described above, which includes a data-analysis-based control for optimized energy harvesting from the solar array(s) and the kinetic energy harvester(s). In the depicted example, floating solar array system 410′ includes adjustable solar panels 413 on adjustable solar array support structures 414, which allow the individual solar panels to, for instance, be adjusted to change slope of the panels, and thereby facilitate tracking movement of the sun across the floating solar array system, and/or facilitate capture of wind-based energy impacting the floating solar array system. Many solar array adjustment variations are possible for a floating solar array system such as described herein.

Also depicted FIG. 4B are multiple lines 460 connecting the floating platform to respective fixed anchor structures 480, each with one or more kinetic energy harvester(s) 415 connected in line between the floating platform and the respective anchor structure 480, so that as the platform moves with waves and/or wind energy on the floating platform, kinetic energy (including, as noted potential energy) is harvested through the extension and contraction of the line (and movement of the energy harvester(s)).

As noted, in one or more embodiments, kinetic energy harvester(s) 415 can include one or more electromagnetic-type energy harvesters 418, one embodiment of which is depicted in FIG. 4C. As illustrated in FIG. 4C, a magnetic material 490, such as in the form of a cylinder, can be positioned to reciprocate (with movement of the respective line coupling the platform to the anchor structure) within a respective coil 491, such as a copper coil, to facilitate generating energy with wave action and/or wind action on the floating platform.

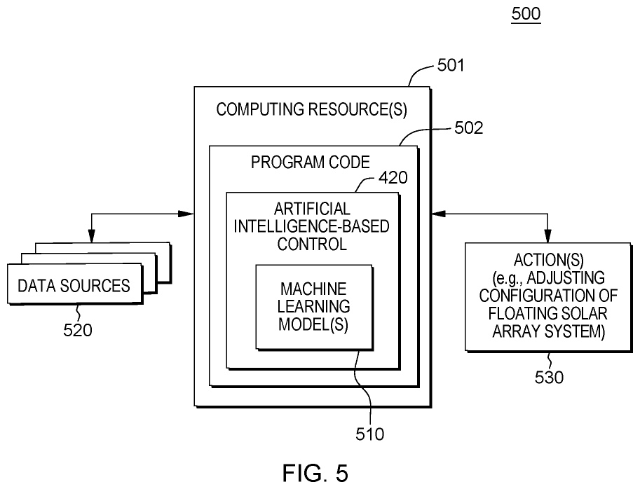

By way of further explanation, FIG. 5 depicts another embodiment of a computing environment or system 500, which can incorporate, or implement, one or more control aspects of an embodiment of the present disclosure. In one or more implementations, system 500 is implemented as part of a computing environment, such as computing environment 100 described above in connection with FIG. 1. System 500 includes one or more computing resources 501 that execute program code 502 that implements, for instance, one or more aspects of a module or facility such as disclosed herein, and which includes an artificial-intelligence-based control 420 (FIG. 4A), which can utilize one or more machine learning models 510, such as described herein. Data, such as satellite imagery, global positioning system (GPS) data for the floating solar array system, weather data, including wind velocity and wind direction, solar irradiance data, sun angle data, and/or other data associated with generating one or more machine learning prediction models to be used in accordance with one or more aspects disclosed herein, is used by a cognitive engine or agent to train machine learning model(s) 510 to (for instance) to predict a natural wave frequency of water upon which the floating solar array system resides, and/or to estimate wave frequency of the water from one or more satellite images, and/or to determine the natural wave frequency of the water by combining a weighted modeled natural wave frequency and a weighted estimated wave frequency, and/or to optimize net energy harvesting from the floating solar array system by balancing potential solar irradiance on the floating solar array and potential kinetic energy on the kinetic energy harvester in dynamically adjusting configuration of the floating solar array system 530, based on the particular application of the machine learning model(s). In one implementation, system 500 can include, or utilize, one or more networks for interfacing various aspects of computing resource(s) 501, as well as one or more data sources 520 providing data, and one or more components, systems, etc., receiving an output, action, etc., 530 of machine learning model(s) 510 to facilitate performance of one or more artificial intelligence system operations. By way of example, the network(s) can be, for instance, a telecommunications network, a local-area network (LAN), a wide-area network (WAN), such as the Internet, or a combination thereof, and can include wired, wireless, fiber-optic connections, etc., operatively coupling the computing resource(s) 501 to the floating solar array and to other data sources. The network(s) can include one or more wired and/or wireless networks that are capable of receiving and transmitting data, including training data for the machine-learning model, and an output solution, recommendation, action, of the machine-learning model(s), such as discussed herein.

In one or more implementations, computing resource(s) 501 house and/or execute program code 502 configured to perform methods in accordance with one or more aspects of the present disclosure. By way of example, computing resource(s) 501 can be a computing-system-implemented resource(s). Further, for illustrative purposes only, computing resource(s) 501 in FIG. 5 is depicted as being a single computing resource. This is a non-limiting example of an implementation. In one or more other implementations, computing resource(s) 501 can, at least in part, be multiple separate computing resources or systems, such as one or more computing resources of a cloud-hosting environment, by way of example only.

Briefly described, in one embodiment, computing resource(s) 501 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed are described further herein with reference to the figures.

In one embodiment, program code 502 executes a cognitive control or agent 420 which includes (and optionally trains) one or more models 510. The models can be trained using training data that can include a variety of types of data, depending on the model and the data sources. In one or more embodiments, program code 502 executing on one or more computing resources 501 applies one or more algorithms of cognitive control 420 to generate and train the model(s), which the program code then utilizes to, for instance, to predict a natural wave frequency of water upon which the floating solar array system resides, and/or to estimate wave frequency of the water from one or more satellite images, and/or to determine the natural wave frequency of the water by combining a weighted modeled natural wave frequency and a weighted estimated wave frequency, and/or to optimize net energy harvesting from the floating solar array system by balancing potential solar irradiance on the floating solar array and potential kinetic energy on the kinetic energy harvester in dynamically adjusting configuration of the floating solar array system 530, based on the particular application of the machine learning model(s). In an initialization or learning stage, program code 502 trains one or more machine learning models 510 using obtained training data that can include, in one or more embodiments, one or more data source inputs, including solar array energy generation data, satellite imagery data, weather data, GPS data, natural wave frequency data, wind velocity and direction data, time of day data, etc., such as described herein.

Data used to train the models, in one or more embodiments of the present disclosure, can include a variety of types of data, such as heterogeneous data generated by multiple data sources and/or data stored in one or more databases accessible by, the computing resource(s). Program code, in embodiments of the present disclosure, can perform data analysis to generate data structures, including algorithms utilized by the program code to predict and/or perform an action. As known, machine-learning-based modeling solves problems that cannot be solved by numerical means alone. In one example, program code extracts features/attributes from training data, which can be stored in memory or one or more databases. The extracted features can be utilized to develop a predictor function, h (x), also referred to as a hypothesis, which the program code utilizes as a model. In identifying machine learning model(s) 510, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from a collection of documents, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces.

In one or more embodiments of the present disclosure, the program code can utilize one or more neural networks to analyze training data and/or collected data to generate an operational machine-learning model 510. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine-learning model, such as described herein.

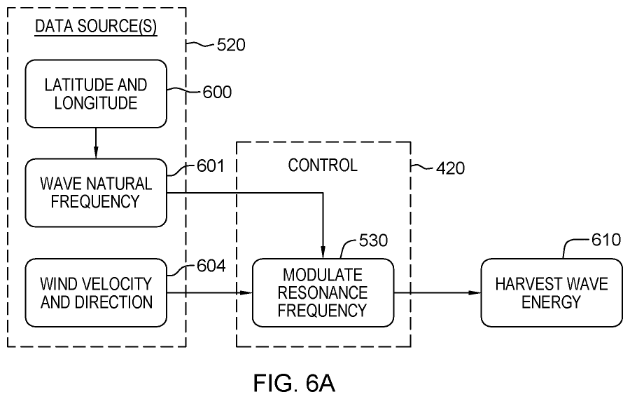

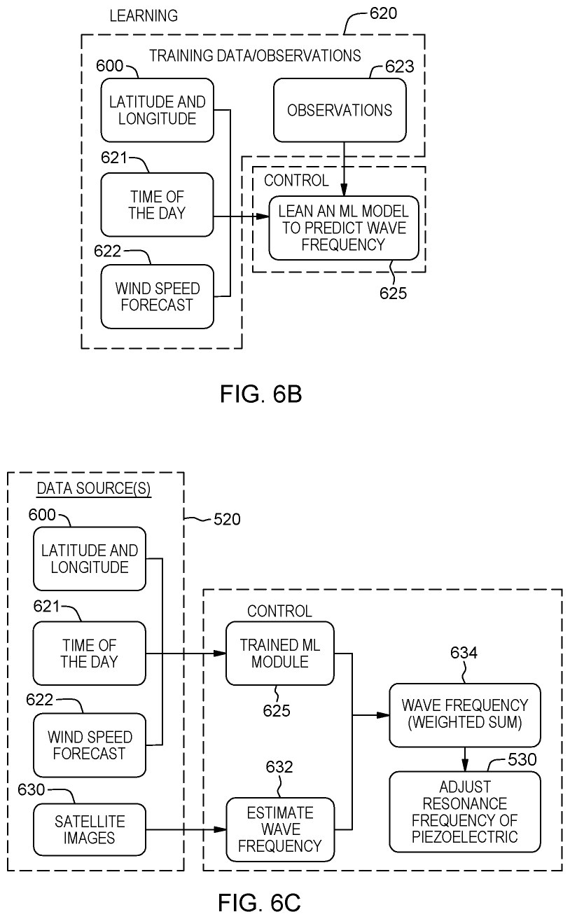

By way of further example, FIG. 6A depicts another embodiment of a data-analysis-based floating solar array control system workflow, in accordance with one or more aspects of the present disclosure. In this embodiment, control 420 obtains (e.g., receives, retrieves, etc.) data from one or more data sources 520, including, for instance, latitudinal and longitudinal data 600 on current location of the floating platform, natural wave frequency data 601, and wind velocity and direction data 604, to determine, for instance, using one or more trained machine learning models, a natural wave frequency of the water, either at a current time or for a forecasted time period, and where the kinetic energy harvester includes a piezoelectric-type energy harvester, such as a piezoelectric spring-type energy harvester, to modulate a piezoelectric resonant frequency 530 of the piezoelectric spring energy harvester to match the determined natural wave frequency of the water, and thereby optimize harvesting of wave energy 610 from the piezoelectric spring energy harvester.

FIGS. 6B & 6C depict embodiments for learning (or training) a machine learning model to predict a natural wave frequency, and to use the trained machine learning model in predicting a modeled natural wave frequency of the water and/or an estimated natural wave frequency of the water, respectively.

Referring to FIG. 6B, machine learning model training uses training data and/or observations including, in one embodiment, latitude and longitude data 600 for a location of the floating platform, time of day data 621, such as for a forecast time period, wind velocity and direction data, including, for instance, forecasted wind speed for the forecast time period 622, as well as observational data 623 from continued operation from the floating solar array system so that the artificial-intelligence-based control learns one or more machine learning (ML) models to predict, for instance, natural wave frequency of the water 625.

By way of example, FIG. 6C depicts one embodiment of a data-analysis-based floating solar array control system workflow using the trained machine learning model. As illustrated, the data-analysis-based control workflow embodiment obtains data from data sources 520, such as one or more of latitude and longitude data on location of the floating platform, time of day data 621, for instance, for a forecast time period, and/or wind speed forecast data 622, etc., that the control uses in association with the trained machine learning model or module 625 to provide a modeled natural wave frequency of the water.

As illustrated in FIG. 6C, one or more satellite images 630 can also be obtained and used, for instance, through data analysis via one or more other trained machine learning models, to estimate natural wave frequency of the water 632 directly from the image(s). In one embodiment, the modeled natural wave frequency and the estimated natural wave frequency are combined in a weighted sum to obtain the wave frequency 634 about the floating platform. For instance, a weighting can be applied to the modeled natural wave frequency of the water, and another weighting can be applied to the estimated wave frequency of the water, with the two weighted frequency values being combined (or added) to obtain the weighted sum natural wave frequency 634. As noted, in one or more embodiment, the data-analysis-based control dynamically adjusts the configuration of the floating solar array system to optimize net energy harvesting of the floating solar array from the floating solar array and the kinetic energy harvester based on the determined environmental condition (e.g., the determined natural wave frequency of the water in the example of FIGS. 6B & 6C). Where the kinetic energy harvester includes a piezoelectric energy harvester, such as a piezoelectric spring-type energy harvester, the control modulates the piezoelectric resonant frequency of the piezoelectric spring energy harvester to match the determined natural wave frequency of the water, and thereby optimize energy generation from the piezoelectric spring energy harvester.

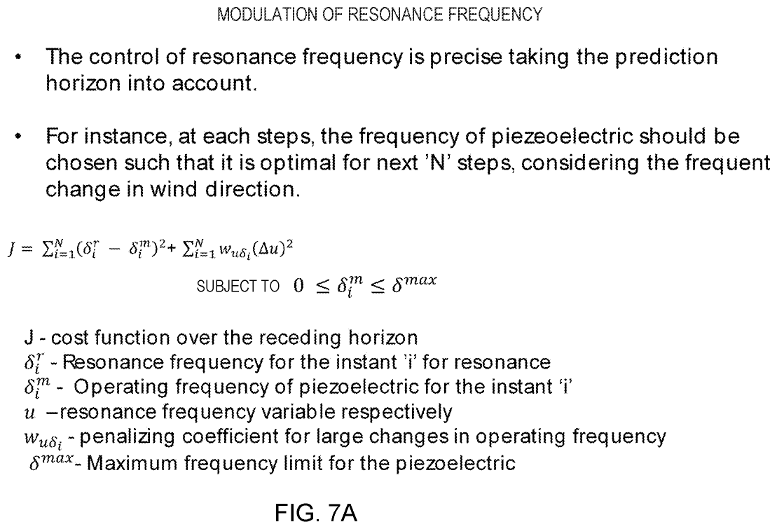

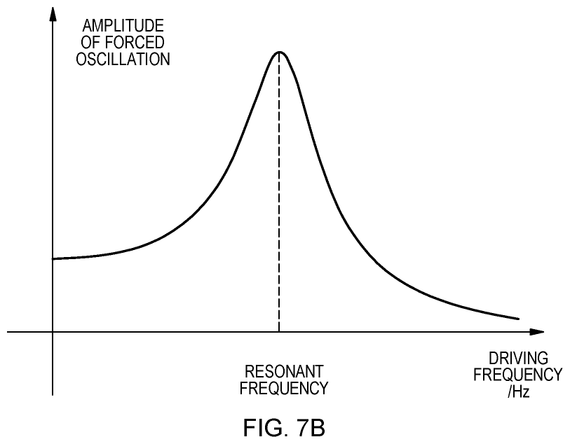

By way of example, FIG. 7A depicts one embodiment of a data-analysis-based control algorithm, implemented by the control, for modulating a resonant frequency of, for instance, a piezoelectric spring energy harvester, such as described herein. As illustrated, the data-analysis-based control algorithm assumes that control of resonance frequency is to be precise, taking the prediction horizon into account. The data-analysis-based control algorithm modulates the frequency of the piezoelectric material at each step by choosing the adjustment such that is optimal for a next N steps, considering, for instance, the frequent change in natural wave frequency and/or wind speed and direction from which the kinetic energy harvester is capturing energy.

As an example, FIG. 7B graphically illustrates a resonant frequency plot of a piezoelectric spring energy harvester to be modulated to facilitate energy harvesting. As is known, by passing a positive or negative DC current through the piezoelectric material, the resonant frequency of the material can be shifted right or left on the graph of FIG. 7B. To facilitate this, a DC power supply can be incorporated, for instance, within the kinetic energy harvester, in one embodiment.

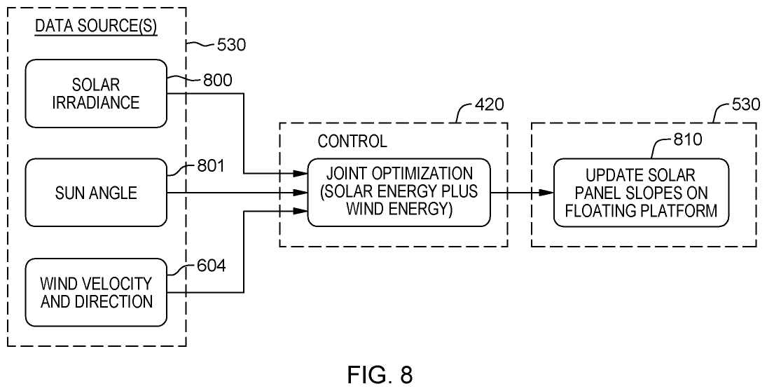

By way of further example, FIGS. 8 & 9 depict another workflow embodiment and example data-analysis-based control algorithm, respectively, for optimizing net energy harvesting of a floating solar array system having both a floating solar array and a kinetic energy harvester(s) by dynamically adjusting configuration of the floating solar array system to optimize the energy harvesting for a particular time period. The workflow and model assume that the floating solar array system is a floating solar array system, such as described above in connection with FIGS. 4A-7B. In this embodiment, the data-analysis-based control workflow enhances energy harvesting from the floating solar array system by jointly optimizing, for instance, harvesting of solar energy from the solar array(s), and harvesting of wind energy using the kinetic energy harvester(s). As illustrated, control 420 obtains data from one or more data sources 520 including, for instance, solar irradiance data 800, such as solar irradiance data for a forecasted time period, sun angle data 801, and/or wind velocity and direction data 604, such as forecasted wind velocity and direction data for a forecast time period.

As described above, the floating solar array, or floating platform, is coupled to an anchor structure by a line having the kinetic energy harvester coupled thereto. With this configuration, wind energy impacting the floating solar array system is captured, at least in part, by the kinetic energy harvester(s). In one or more implementations, control 420 seeks to optimize net energy harvesting of the floating solar array system for a forecast time interval, that is, to jointly optimize both solar energy harvesting and wind energy harvesting (in addition to any wave energy harvesting). In one embodiment, the dynamic adjustment of configuration of the floating solar array 530 can include updating the solar array panel slopes on the floating platform 810, as well as, an orientation of the floating platform, to optimize conversion of wind energy to electrical energy. For instance, where the forecast time interval encompasses a nighttime interval, meaning that there is no solar energy capture, then the position of the solar panels can be dynamically adjusted to, for instance, a raised position, to enhance the profile of the floating solar array system on the water, and thereby increase kinetic energy harvesting. In one example, this can include raising the solar array panels to a greater than 45° angle relative to the floating platform (such as a 90° angle), and turning or rotating the floating platform so that the solar array panels are turned towards the wind direction.

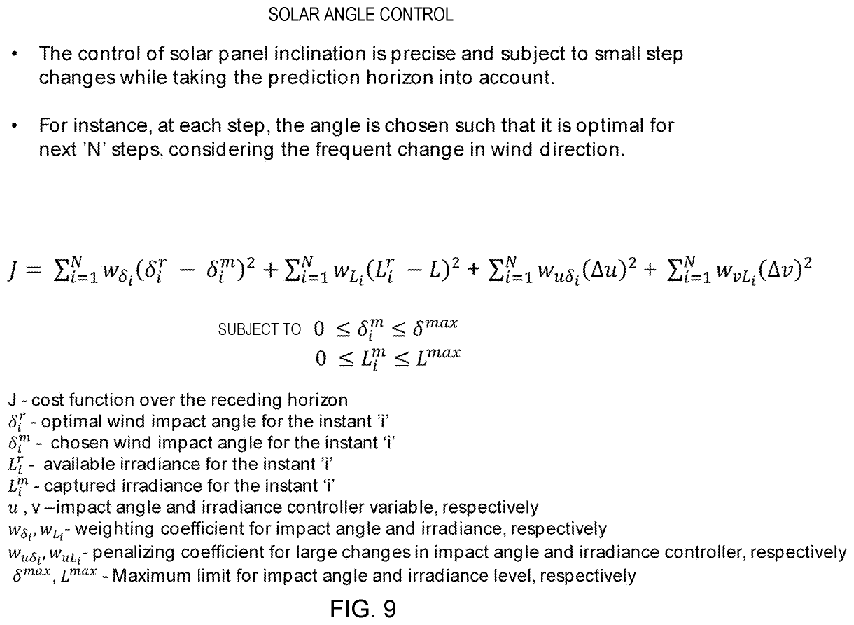

As noted, FIG. 9 depicts one example of a data-analysis-based control algorithm for optimizing net energy harvesting of a floating solar array system from the floating solar array and kinetic energy harvester of the system by dynamically controlling solar array panel angles, in accordance with the present disclosure. As illustrated, the control of solar panel inclination or slope is, in one or more embodiments, precise and subject to small step changes, while taking the predicted time period into account. For instance, at each step, the angle is chosen so that it is optimal for the next N steps, considering a frequent change in wind direction. The data-analysis-based control algorithm maximizes the net energy harvesting of the floating solar array system, by considering both energy harvesting of the floating solar array and that of the kinetic energy harvester, based on the one or more determined environmental conditions to effect the floating solar array system for, for instance, a forecast time period.

The terminology used herein is for the purpose of describing particular embodiments only and is not intended to be limiting of the disclosure. As used herein, the singular forms “a”. “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating energy harvesting, the computer-implemented method comprising:
obtaining a data-analysis-based control to control energy harvesting from a floating solar array system on water, the floating solar array system including a floating solar array to harvest solar energy and a kinetic energy harvester to harvest kinetic energy, the data-analysis-based control being configured to:
determine an environmental condition to effect the floating solar array system; and
dynamically adjust a configuration of the floating solar array system to optimize net energy harvesting of the floating solar array system from the floating solar array and the kinetic energy harvester based on the determined environmental condition to effect the floating solar array system.

2. The computer-implemented method of claim 1, wherein the floating solar array of the floating solar array system is coupled to an anchor structure by a line having the kinetic energy harvester coupled thereto, the kinetic energy harvester including a piezoelectric spring energy harvester, and wherein the data-analysis-based control is further configured to:
determine a natural wave frequency of the water; and
modulate a piezoelectric resonant frequency of the piezoelectric spring energy harvester to match the determined natural wave frequency of the water to optimize energy generation from the piezoelectric spring energy harvester.

3. The computer-implemented method of claim 2, wherein the data-analysis-based control is configured to determine the natural wave frequency of the water using a pre-trained, machine learning model trained to provide a modeled natural wave frequency of the water using latitudinal and longitudinal data for a location of the floating solar array system, time of day data, and wind speed data for the floating solar array system location.

4. The computer-implemented method of claim 3, wherein the data-analysis-based control is further configured to determine the natural wave frequency of the water by:
obtaining an estimated natural wave frequency of the water using satellite image data of the water; and
determining the natural wave frequency of the water using both the modeled natural wave frequency of the water and the estimated natural wave frequency of the water.

5. The computer-implemented method of claim 4, wherein the data-analysis-based control is further configured to determine the natural wave frequency of the water using a weighting of the modeled natural wave frequency of the water combined with a weighting of the estimated natural wave frequency of the water.

6. The computer-implemented method of claim 1, wherein the floating solar array is coupled to an anchor structure by a line having the kinetic energy harvester coupled thereto, and wherein the control is further configured to:
determine solar irradiance on the floating solar array for a forecast time period;
determine kinetic energy on the kinetic energy harvester for the forecast time period; and
dynamically adjust the configuration of the floating solar array system to optimize net energy harvesting of the floating solar array system for the forecast time period using the determined solar irradiance and the determined kinetic energy.

7. The computer-implemented method of claim 6, wherein the floating solar array comprises adjustable floating solar array panels, and the dynamically adjusting the configuration of the floating solar array system comprises dynamically adjusting slope of one or more floating solar array panels of the floating solar array to facilitate optimizing harvesting of kinetic energy for the forecast time period, and thereby optimize net energy harvesting of the floating solar array system for the forecast time period based on the determined environmental condition to effect the floating solar array system, and wherein the environmental condition is selected from the group consisting of: wave action to effect the floating solar array system for the forecast time interval; wind to effect the floating solar array system for the forecast time interval; and solar irradiance to effect the solar array system for the forecast time interval.

8. The computer-implemented method of claim 7, wherein the floating solar array of the floating solar array system is coupled to an anchor structure by a line having the kinetic energy harvester coupled thereto, the kinetic energy harvester including a piezoelectric spring energy harvester, and wherein the data-analysis-based control is further configured to:
determine a natural wave frequency of the water; and
modulate a piezoelectric resonant frequency of the piezoelectric spring energy harvester to match the determined natural wave frequency of the water to optimize energy generation from the piezoelectric spring energy harvester.

9. The computer-implemented method of claim 1, wherein the floating solar array of the floating solar array system is coupled to an anchor structure by a line having the kinetic energy harvester coupled thereto, the kinetic energy harvester including an electromagnetic energy harvester, and wherein the data-analysis-based control is further configured to:
determine solar irradiance on the floating solar array for a forecast time period;
determine kinetic energy on the kinetic energy harvester for the forecast time period; and
dynamically adjust the configuration of the floating solar array system to optimize net energy harvesting of the floating solar array system for the forecast time period using the determined solar irradiance and the determined kinetic energy.

10. A computer system for facilitating energy harvesting, the computer system comprising:
a memory; and
at least one processor in communication with the memory, wherein the computer system is configured to perform a method, the method comprising:
obtaining a data-analysis-based control to control energy harvesting from a floating solar array system on water, the floating solar array system including a floating solar array to harvest solar energy and a kinetic energy harvester to harvest kinetic energy, the data-analysis-based control being configured to:
determine an environmental condition to effect the floating solar array system; and
dynamically adjust a configuration of the floating solar array system to optimize net energy harvesting of the floating solar array system from the floating solar array and the kinetic energy harvester based on the determined environmental condition to effect the floating solar array system.

11. The computer system of claim 10, wherein the floating solar array of the floating solar array system is coupled to an anchor structure by a line having the kinetic energy harvester coupled thereto, the kinetic energy harvester including a piezoelectric spring energy harvester, and wherein the data-analysis-based control is further configured to:
determine a natural wave frequency of the water; and
modulate a piezoelectric resonant frequency of the piezoelectric spring energy harvester to match the determined natural wave frequency of the water to optimize energy generation from the piezoelectric spring energy harvester.

12. The computer system of claim 11, wherein the data-analysis-based control is configured to determine the natural wave frequency of the water using a pre-trained, machine learning model trained to provide a modeled natural wave frequency of the water using latitudinal and longitudinal data for a location of the floating solar array system, time of day data, and wind speed data for the floating solar array system location.

13. The computer system of claim 12, wherein the data-analysis-based control is further configured to determine the natural wave frequency of the water by:
obtaining an estimated natural wave frequency of the water using satellite image data of the water; and
determining the natural wave frequency of the water using both the modeled natural wave frequency of the water and the estimated natural wave frequency of the water.

14. The computer system of claim 10, wherein the floating solar array is coupled to an anchor structure by a line having the kinetic energy harvester coupled thereto, and wherein the data-analysis-based control is further configured to:
determine solar irradiance on the floating solar array for a forecast time period;
determine kinetic energy on the kinetic energy harvester for the forecast time period; and
dynamically adjust the configuration of the floating solar array system to optimize net energy harvesting of the floating solar array system for the forecast time period using the determined solar irradiance and the determined kinetic energy.

15. The computer system of claim 14, wherein the floating solar array comprises adjustable floating solar array panels, and the dynamically adjusting the configuration of the floating solar array system comprises dynamically adjusting slope of one or more floating solar array panels of the floating solar array to facilitate optimizing harvesting of kinetic energy for the forecast time period, and thereby optimize net energy harvesting of the floating solar array system for the forecast time period based on the determined environmental condition to effect the floating solar array system, and wherein the environmental condition is selected from the group consisting of: wave action to effect the floating solar array system for the forecasted time interval; wind to effect the floating solar array system for the forecast time interval; and solar irradiance to effect the solar array system for the forecast time interval.

16. The computer system of claim 15, wherein the floating solar array of the floating solar array system is coupled to an anchor structure by a line having the kinetic energy harvester coupled thereto, the kinetic energy harvester including a piezoelectric spring energy harvester, and wherein the data-analysis-based control is further configured to:
determine a natural wave frequency of the water; and
modulate a piezoelectric resonant frequency of the piezoelectric spring energy harvester to match the determined natural wave frequency of the water to optimize energy generation from the piezoelectric spring energy harvester.

17. The computer system of claim 10, wherein the floating solar array of the floating solar array system is coupled to an anchor structure by a line having the kinetic energy harvester coupled thereto, the kinetic energy harvester including an electromagnetic kinetic energy harvester, and wherein the data-analysis-based control is further configured to:
determine solar irradiance on the floating solar array for a forecast time period;
determine kinetic energy on the kinetic energy harvester for the forecast time period; and
dynamically adjust the configuration of the floating solar array system to optimize net energy harvesting of the floating solar array system for the forecast time period using the determined solar irradiance and the determined kinetic energy.

18. A computer program product for facilitating energy harvesting, the computer program product comprising:
one or more computer readable storage media and program instructions collectively stored on the one or more computer readable storage media readable by at least one processer to:
obtain a data-analysis-based control to control energy harvesting from a floating solar array system on water, the floating solar array system including a floating solar array to harvest solar energy and a kinetic energy harvester to harvest kinetic energy, the data-analysis-based control being configured to:
determine an environmental condition to effect the floating solar array system; and
dynamically adjust a configuration of the floating solar array system to optimize net energy harvesting of the floating solar array system from the floating solar array and the kinetic energy harvester based on the determined environmental condition to effect the floating solar array system.

19. The computer program product of claim 18, wherein the floating solar array of the floating solar array system is coupled to an anchor structure by a line having the kinetic energy harvester coupled thereto, the kinetic energy harvester including a piezoelectric spring energy harvester, and wherein the program instructions readable by the at least one processor to provide data-analysis-based control of energy harvesting are further readable by the at least one processor to:
determine a natural wave frequency of the water; and
modulate a piezoelectric resonant frequency of the piezoelectric spring energy harvester to match the determined natural wave frequency of the water to optimize energy generation from the piezoelectric spring energy harvester.

20. The computer program product of claim 18, wherein the floating solar array is coupled to an anchor structure by a line having the kinetic energy harvester coupled thereto, and wherein the program instructions readable by the at least one processor to provide data-analysis-based control of energy harvesting from the floating solar array system are further readable by the at least one processor to:
determine solar irradiance on the floating solar array for a forecast time period;
determine kinetic energy on the kinetic energy harvester for the forecast time period; and
dynamically adjust the configuration of the floating solar array system to optimize net energy harvesting of the floating solar array system for the forecast time period using the determined solar irradiance and the determined kinetic energy.
